(19) United States
(12) Patent Application Publication
(10) Pub. No.: US 2025/0186944 A1
(43) Pub. Date: Jun. 12, 2025

(54) HYBRID ELECTRIC VEHICLE

(71) Applicant: TOYOTA JIDOSHA KABUSHIKI KAISHA, Toyota-shi (JP)

(72) Inventors: Masahide IIDA, Toyota-shi (JP); Tsubasa MIGITA, Sakai-shi (JP)

(73) Assignee: TOYOTA JIDOSHA KABUSHIKI KAISHA, Toyota-shi (JP)

(21) Appl. No.: 18/788,419

(22) Filed: Jul. 30, 2024

(30) Foreign Application Priority Data
Dec. 6, 2023 (JP) 2023-206261

(51) Int. Cl. B01D 53/86; B60K 6/28; B60L 50/64; H01M 50/249; H01M 50/325; H01M 50/358

(52) U.S. Cl. CPC B01D 53/8612; B60L 50/64; H01M 50/249; H01M 50/325; H01M 50/358; B01D 2257/304; B01D 2259/4566; B60K 6/28; B60Y 2200/92; B60Y 2400/112; H01M 2220/20

(57) ABSTRACT

An hybrid electric vehicle comprising: an engine and a motor that are driving power sources; a battery pack that houses sulfide all-solid-state battery cells and supplies electric power to the motor; a first passage that communicates the inside of the battery pack with an exhaust passage of the engine; a second passage that communicates the inside of the battery pack with the outside air; first and second opening and closing mechanisms that open and close the first and second passages, respectively; and a control device that opens the first and second passages by the first and second opening and closing mechanisms so that hydrogen sulfide gas in the battery pack is discharged to the exhaust passage.

### CROSS-REFERENCE TO RELATED APPLICATION

This application claims priority to Japanese Patent Application No. 2023-206261 filed on Dec. 6, 2023, incorporated herein by reference in its entirety.

### BACKGROUND

### 1. Technical Field

The present disclosure relates to a hybrid electric vehicle.

### 2. Description of Related Art

There is a battery pack that houses sulfide all-solid-state battery cells (see, for example, Japanese Unexamined Patent Application Publication No. 2022-014295 (JP 2022-014295 A)).

### SUMMARY

It is conceivable to employ such a battery pack in a hybrid electric vehicle. For example, when hydrogen sulfide gas generated in the sulfide all-solid-state battery cell leaks from the battery pack, there is a possibility that the hydrogen sulfide gas flows into a vehicle cabin and causes an abnormal odor.

An object of the present disclosure is to provide a hybrid electric vehicle in which generation of an abnormal odor in a vehicle cabin is suppressed.

A hybrid electric vehicle of the present disclosure includes:
an engine and a motor serving as traveling power sources;
a battery pack that houses sulfide all-solid-state battery cells and is configured to supply electric power to the motor;
a first passage that communicates an inside of the battery pack and an exhaust passage of the engine;
a second passage that communicates the inside of the battery pack and outside air;
a first opening and closing mechanism and a second opening and closing mechanism configured to open and close the first passage and the second passage, respectively; and a control device configured to cause the first opening and closing mechanism and the second opening and closing mechanism to open the first passage and the second passage, respectively, to discharge hydrogen sulfide gas in the battery pack to the exhaust passage.

An exhaust gas control catalyst may be provided on the exhaust passage. The first passage may communicate with a downstream side of the exhaust gas control catalyst on the exhaust passage.

The control device may include:
an acquisition unit configured to acquire an ammonia concentration of exhaust gas that has passed through the exhaust gas control catalyst; and
a control unit configured to cause the first opening and closing mechanism and the second opening and closing mechanism to close the first passage and the second passage, respectively, when the ammonia concentration is lower than a threshold value at which the hydrogen sulfide gas is neutralizable, and cause the first opening and closing mechanism and the second opening and closing mechanism to open the first passage and the second passage, respectively, when the ammonia concentration is equal to or higher than the threshold value.

A blower fan may be provided to accelerate discharge of gas in the battery pack to the first passage by introducing air into the battery pack from the second passage. The control unit may be configured to stop the blower fan when the ammonia concentration is lower than the threshold value, and drive the blower fan when the ammonia concentration is equal to or higher than the threshold value.

It is possible to provide the hybrid electric vehicle in which the generation of the abnormal odor in the vehicle cabin is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a hybrid electric vehicle;

FIG. 2 is a schematic configuration diagram of an engine and a battery pack; and

FIG. 3 is a flowchart illustrating hydrogen sulfide gas emission control.

### DETAILED DESCRIPTION OF EMBODIMENTS

### Schematic Configuration of Hybrid Electric Vehicle

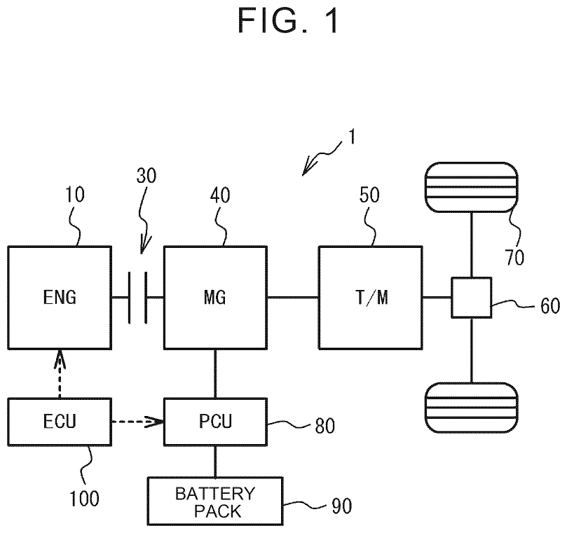

FIG. 1 is a schematic configuration diagram of a hybrid electric vehicle 1. In hybrid electric vehicle 1, a clutch 30, a motor 40, and a transmission 50 are provided in this order in a power transmission path from the engine 10 to the drive wheels 70. The engine 10 and the motor 40 are mounted as a driving source for traveling of hybrid electric vehicle 1. Engine 10 is, for example, a gasoline engine, but may also be a diesel engine. The transmission 50 and the left and right drive wheels 70 are connected via a differential gear 60. The transmission 50 includes a torque converter and an automatic transmission.

The clutch 30 is provided between the engine 10 and the motor 40 on the same power transmission path. The clutch 30 receives the supply of the hydraulic pressure from the released state and is brought into an engaged state to connect the power transmission between the engine 10 and the motor 40. The clutch 30 is released in response to the stop of the hydraulic pressure supply, and shuts off the power transmission between the engine 10 and the motor 40.

The motor 40 is connected to the battery pack 90 via a PCU80. The motor 40 functions as a driving power source of hybrid electric vehicle 1 in response to power supply from the battery pack 90. The motor 40 also functions as a generator that charges the battery pack 90 in response to power transmission from the engine 10 and the drive wheels 70.

PCU80 is controlled by a ECU100 which will be described later. In the power running operation in which the motor 40 outputs torque, PCU80 converts the DC voltage of the battery pack 90 into an AC voltage and adjusts the electric power supplied to the motor 40. In the regenerative operation generated by the motor 40, PCU80 converts the AC voltage from the motor 40 into a DC voltage and adjusts the regenerative power supplied to the battery pack 90.

Hybrid electric vehicle 1 is provided with an ECU (Electronic Control Unit) 100 as a control device for the same vehicle. ECU100 is an electronic control unit including an arithmetic processing unit that performs various arithmetic processing related to travel control of vehicles, and a memory that stores control programs and data. ECU100 is an exemplary hybrid electric vehicle 1 control device and functionally realizes an acquisition unit and a control unit, which will be described in detail later.

ECU100 causes hybrid electric vehicle to travel in one of a motor running mode and a hybrid running mode. In the motor driving mode, ECU100 stops the engine 10, releases the clutch 30, and travels by the power of the motor 40. In the hybrid driving mode, the clutch 30 is engaged and driven by at least the power of the engine 10. In the hybrid driving mode, the driving of the engine 10 can be assisted by the output of the motor 40.

### Schematic Configuration of the Engine

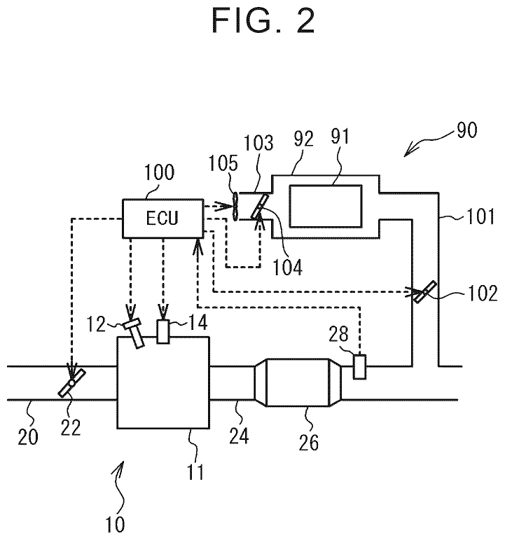

FIG. 2 is a schematic configuration diagram of the engine 10 and the battery pack 90. The engine 10 includes an engine main body 11, an intake passage 20, and an exhaust passage 24. The engine main body 11 is a multi-cylinder engine having a plurality of cylinders. The engine main body 11 is provided with an in-cylinder injection valve 12 and an ignition plug 14. The in-cylinder injection valve 12 directly injects fuel into the combustion chamber of the engine 10. Note that a port injection valve may be provided instead of the in-cylinder injection valve 12 or in addition to the in-cylinder injection valve. The ignition plug 14 ignites an air-fuel mixture of fuel and air. A throttle valve 22 is provided in the intake passage 20. The throttle valve 22 is driven by, for example, an actuator (not shown) to adjust the intake air amount.

An exhaust gas control catalyst 26 is provided in the exhaust passage 24. When the air-fuel ratio of the exhaust gas flowing into the exhaust gas control catalyst 26 is within a narrow range in the vicinity of the stoichiometry, the exhaust gas control catalyst controls the harmful components in the exhaust gas. An ammonia concentration sensor 28 is provided downstream of the exhaust gas control catalyst 26. Exhaust gases including HC and CO and water flow into the exhaust gas control catalyst 26. Hydrogen is generated in the exhaust gas control catalyst 26 by the catalytic action. When NOx contained in the exhaust gas reacts with hydrogen, ammonia is generated. This may increase the concentration of ammonia in the exhaust gas that has passed through the exhaust gas control catalyst 26.

The battery pack 90 includes a cell stack 91 and a case 92. The cell stack 91 is accommodated in the case 92. In the cell stack 91, a plurality of sulfide all-solid-state battery cells are stacked. The case 92 has a case shape. The inside of the case 92 and the downstream side of the exhaust gas control catalyst 26 in the exhaust passage 24 communicate with each other through the first passage 101. A first valve 102 is provided in the first passage 101. The first valve 102 is an example of a first opening/closing mechanism. A second passage 103 communicating with the outside air is connected to the case 92. A second valve 104 is provided in the second passage 103. The second valve 104 is an example of a second opening/closing mechanism. In addition, a blower fan 105 is provided in the vicinity of the second passage 103. The blower fan 105 can blow air toward the second passage 103. The first valve 102, the second valve 104, and the blower fan 105 are controlled 10 by a ECU100.

ECU100 normally closes the first valve 102 and the second valve 104 and stops the blower fan 105, and opens the first valve 102 and the second valve 104 to drive the blower fan 105 when a predetermined condition is satisfied. Thus, the hydrogen sulfide gas generated from the cell stack 91 is discharged from the inside of the case 92 to the exhaust passage 24. In this way, the flow of the hydrogen sulfide gas into the vehicle cabin is suppressed. In addition, the hydrogen sulfide gas is suppressed from staying in the case 92 for a long time. Therefore, the failure of the electronic component in the case 92 and the corrosion of the metal component due to the hydrogen sulfide gas are suppressed.

When the second valve 104 is closed when the first valve 102 is opened, the inside of the case 92 also becomes a negative pressure due to the influence of the negative pressure in the exhaust passage 24. This may affect the cell stack 91. Therefore, when the first valve 102 is opened, the second valve 104 is opened, so that the inside of the case 92 is suppressed from becoming negative pressure.

### Hydrogen Sulfide Gas Emission Control

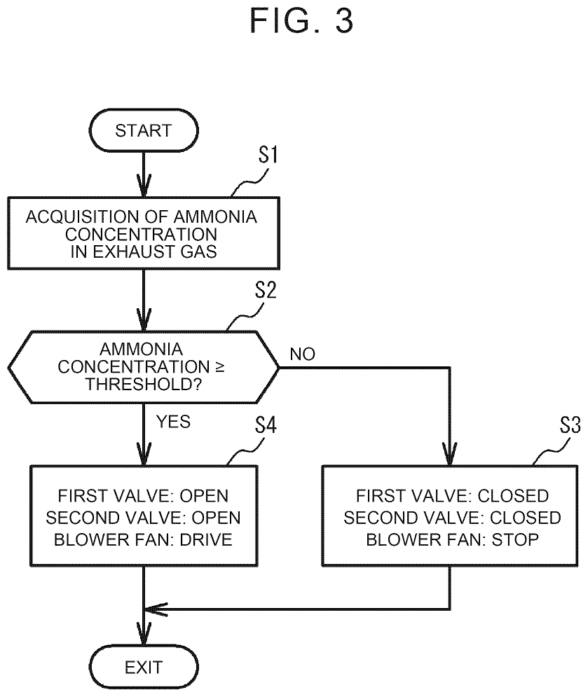

FIG. 3 is a flowchart illustrating hydrogen sulfide gas emission control. ECU100 acquires the ammonia concentration of the exhaust gas by the ammonia concentration sensor 28 (S1). The ammonia concentration is not limited to the acquisition by the sensor, and may be calculated by an arithmetic expression. For example, the ammonia concentration may be calculated based on the in-cylinder temperature or the air-fuel ratio, or 30 the ammonia concentration may be calculated based on the temperature of the exhaust gas control catalyst 26. S1 is an exemplary process executed by the acquisition unit.

Next, ECU100 determines whether or not the ammonia-concentration is equal to or greater than a threshold value (S2). The threshold value is set to an ammonia concentration capable of neutralizing the hydrogen sulfide gas. If S2 is No, ECU100 closes the first valve 102 and the second valve 104 and S3 the blower fan 105.

If S2 is Yes, ECU100 opens the first valve 102 and the second valve 104 to drive the blower fan 105 (S4). Thus, air is introduced into the case 92 through the second passage 103 by the blower fan 105. The hydrogen sulfide gas in the case 92 is discharged to the downstream side of the exhaust gas control catalyst 26 in the exhaust passage 24 via the first passage 101. S4 is an exemplary process executed by the control unit.

The ammonia in the exhaust gas that has passed through the exhaust gas control catalyst 26 and the hydrogen sulfide gas that has been discharged from the case 92 undergo a neutralization reaction as follows to generate ammonium sulfide.

2NH₃+H₂S→(NH₄)2S

In this way, the hydrogen sulfide gas is prevented from being directly discharged to the outside air.

Although the first valve 102 is provided in the first passage 101 in the above embodiment, the first valve 102 is not limited to being provided in the first passage 101. For example, the first valve 102 may be provided in the case 92 so as to open and close a connection portion between the case 92 and the first passage 101. Similarly, a second valve 104 may be provided in the case 92 so as to open and close a connection portion between the second passage 103 and the second valve 104. In addition, a shutter mechanism may be used instead of the first valve 102 and the second valve 104. The blower fan 105 is disposed outside the case 92, but may be provided in the first passage 101, the first valve 102, or the case 92.

In the above embodiment, the driving power source including the engine 10 and the motor 40 is exemplified as an example of hybrid electric vehicle, but the present disclosure is not limited thereto. For example, hybrid electric vehicle may include an engine, a first motor, and a second motor as a driving power source, and a planetary gear mechanism including a sun gear coupled to the first motor, a ring gear coupled to the drive wheels and the second motor, and a carrier coupled to the engine.

Although the embodiments of the present disclosure have been described in detail above, the present disclosure is not limited to such specific embodiments, and various modifications and changes can be made within the scope of the gist of the present disclosure described in the claims.

What is claimed is:

1. A hybrid electric vehicle comprising:
an engine and a motor serving as traveling power sources;
a battery pack that houses sulfide all-solid-state battery cells and is configured to supply electric power to the motor;
a first passage that communicates an inside of the battery pack and an exhaust passage of the engine;
a second passage that communicates the inside of the battery pack and outside air;
a first opening and closing mechanism and a second opening and closing mechanism configured to open and close the first passage and the second passage, respectively; and
a control device configured to cause the first opening and closing mechanism and the second opening and closing mechanism to open the first passage and the second passage, respectively, to discharge hydrogen sulfide gas in the battery pack to the exhaust passage.

2. The hybrid electric vehicle according to claim 1, wherein:
an exhaust gas control catalyst is provided on the exhaust passage;
the first passage communicates with a downstream side of the exhaust gas control catalyst on the exhaust passage; and
the control device includes:
an acquisition unit configured to acquire an ammonia concentration of exhaust gas that has passed through the exhaust gas control catalyst; and
a control unit configured to cause the first opening and closing mechanism and the second opening and closing mechanism to close the first passage and the second passage, respectively, when the ammonia concentration is lower than a threshold value at which the hydrogen sulfide gas is neutralizable, and cause the first opening and closing mechanism and the second opening and closing mechanism to open the first passage and the second passage, respectively, when the ammonia concentration is equal to or higher than the threshold value.

3. The hybrid electric vehicle according to claim 2, further comprising a blower fan configured to accelerate discharge of gas in the battery pack to the first passage by introducing air into the battery pack from the second passage, wherein the control unit is configured to stop the blower fan when the ammonia concentration is lower than the threshold value, and drive the blower fan when the ammonia concentration is equal to or higher than the threshold value.
